(19) United States
(12) Patent Application Publication
(10) Pub. No.: US 2015/0311753 A1
(43) Pub. Date: Oct. 29, 2015

(54) ETHERNET POE TO USB ADAPTER DEVICE

(71) Applicant: Pavlov Media, Inc., Champaign, IL (US)

(72) Inventor: Mark Scifres, Champaign, IL (US)

(73) Assignee: Pavlov Media, Inc., Champaign, IL (US)

(21) Appl. No.: 14/261,172

(22) Filed: Apr. 24, 2014

(51) Int. Cl. H02J 13/00; G06F 1/26; H02J 3/00; H04L 12/40

(52) U.S. Cl. CPC H02J 13/0096; H04L 12/40045; G06F 1/266; H02J 3/00

(57) ABSTRACT

A PoE to USB adapter comprises the electronic circuitry to take the incoming PoE signal and extract 5 volts DC from the power segment of the signal and provide that voltage, along with the bi-directional data contained within the PoE signal to a standard USB 3.0 connector.

### FIELD OF THE INVENTION

The present invention relates generally to the field of internet connectivity, and more particularly relates to circuitry for extracting and providing a 5 volt DC USB power source from an existing Power over Ethernet (PoE) voltage source, while passing through the power and Ethernet bi-directional data signal on a USB 3.0 connector at up to 1 Gbps.

### BACKGROUND OF THE INVENTION

The rapid explosion of devices such as tablets present some problems when mounting them as fixed devices and providing power and data to the device. In normal operation the tablet would have a separate power supply to charge an internal battery requiring a wall outlet to provide the AC power. The Ethernet connection is usually made via a wireless connection. This invention allows the tablet to be permanently mounted to a wall or other surface for security and provide the power and data signal through a single connector. In areas that do not have wireless Ethernet available, a wired Ethernet connection may provide the only means of connection to the Internet. The use of a wired Ethernet data connection rather than a wireless connection also allows for greater data throughput while providing better communications security.

### SUMMARY OF THE INVENTION

The invention provides a method of converting the voltage and data from a standard IEEE 802.3af or 802.3at compliant PoE Ethernet RJ-45 connector to the correct voltage and bi directional data on standard Type A USB 3.0 connector. The USB 3.0 connection is USB 2.0 backward compliant. The standard PoE voltage of 36-72 VDC is reduced to 5 VDC at a maximum of 6 amps to meet the IEEE 802.3at requirement of 25.5 watts of output power to the end device. In an embodiment, the system of the present invention is housed in a small enclosure with the input and output connectors at opposite ends, although in other embodiments the system can be integrated into larger systems or housed differently.

### THE FIGURES

FIG. 1 shows a schematic block diagram of the invention.

FIG. 2 shows an embodiment wherein the system of FIG. 1 is integrated into a tablet or similar device.

### DETAILED DESCRIPTION OF THE INVENTION

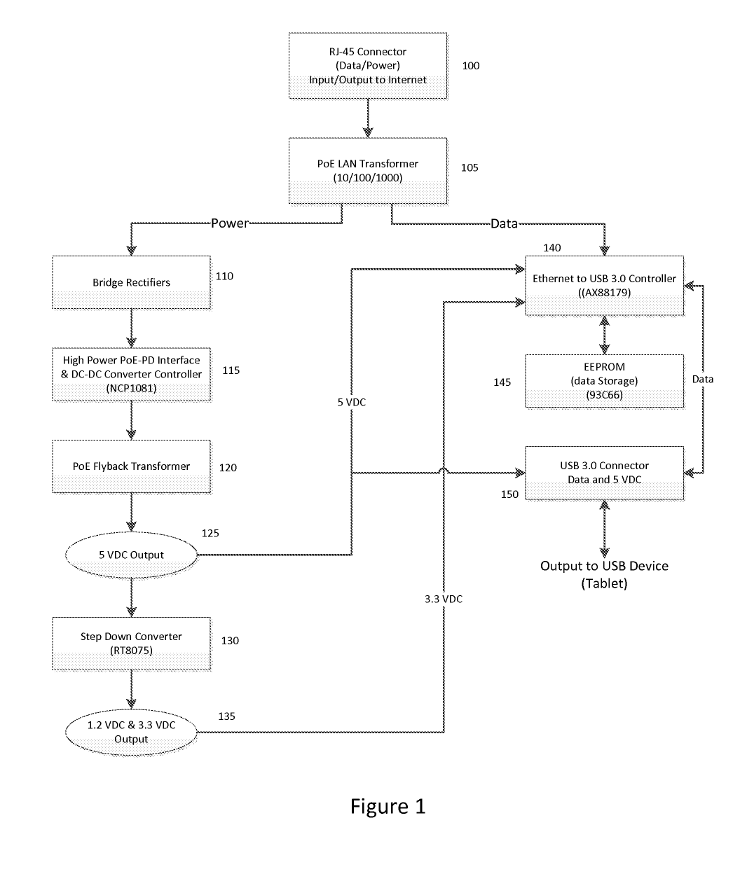

Referring to FIG. 1, a conventional PoE signal containing both data and AC power is supplied to the system through an RJ-45 connector (100). The data portion of the signal can be as fast as 1 Gigabit per second (Gbps). The combined data and power are then run through a PoE LAN transformer (105), splitting the AC power from the data signal.

The PoE LAN transformer provides coupling and impedance matching between the Ethernet connection (100) and the Ethernet to USB 3.0 Controller IC (140) and has low crosstalk.

In an embodiment, the AC power is converted to DC through, for example, a pair of bridge rectifiers (110) and, in some embodiments, a voltage regulator that provides a stable, polarity insensitive, DC voltage input to a DC-DC converter controller chip (115). In an embodiment, the DC-DC converter is an IEEE 802.3at compliant switching power supply that can supply up to 40 watts of power at the output, such as the NCP1081 device available from On Semiconductor. The output of the converter is a stable 5 VDC.

In an embodiment, attached to the DC-DC converter is an isolated flyback transformer (120) circuit which provides feedback loop to the output of the DC-DC converter for better regulation of the output voltage. At the same time, it provides isolation between the input and output stages to reduce the generation of EMI signals with changing output loads. The 5 VDC output voltage (125) is then applied to a USB 3.0 connector (150) and to an Ethernet to USB 3.0 Controller or communications interface (140).

A portion of the 5 VDC is applied to a step down converter (130) which provides 1.2 VDC and 3.3 VDC (135) to power the Ethernet to USB 3.0 Controller (140). The controller provides a bidirectional communications interface that converts IP protocol Ethernet data to USB protocol data, and vice versa. An EEPROM (145) is connected to the controller to provide the firmware needed to program the Ethernet to USB 3.0 Controller (140). The controller 140 may, in an embodiment, be an Asix AX88179 device or similar.

The data signal from the PoE LAN transformer (105) is applied to the Ethernet to USB 3.0 Controller (140) for conversion from IP protocol data to USB protocol data. The output of the Ethernet to USB 3.0 Controller (140) is then sent to the USB 3.0 connector (150) and combined with the 5 VDC USB power.

For communications from a USB device connected to the system of the present invention, the data from the connected device enters the USB 3.0 connector (150) and passes through the Ethernet to USB 3.0 Controller (140) where it is converted back from USB 3.0 protocol to IP protocol. The data then continues back to the PoE LAN transformer (105) and is sent out via the RJ-45 Ethernet connector to the internet.

The device shown in FIG. 1 can, in some embodiments, be housed within an independent enclosure of any suitable design. The enclosure can be fabricated of any suitable material known in the art, for example ABS or other plastics. In such an arrangement, the device operates as an external interface between a USB 3.0 connection, such as found on tablets or other similar devices, and a standard ethernet connection. As is understood in the art, the USB 3.0 connection provides both power and data to the connected device, and USB 3.0 is backward-compatible to earlier USB standards.

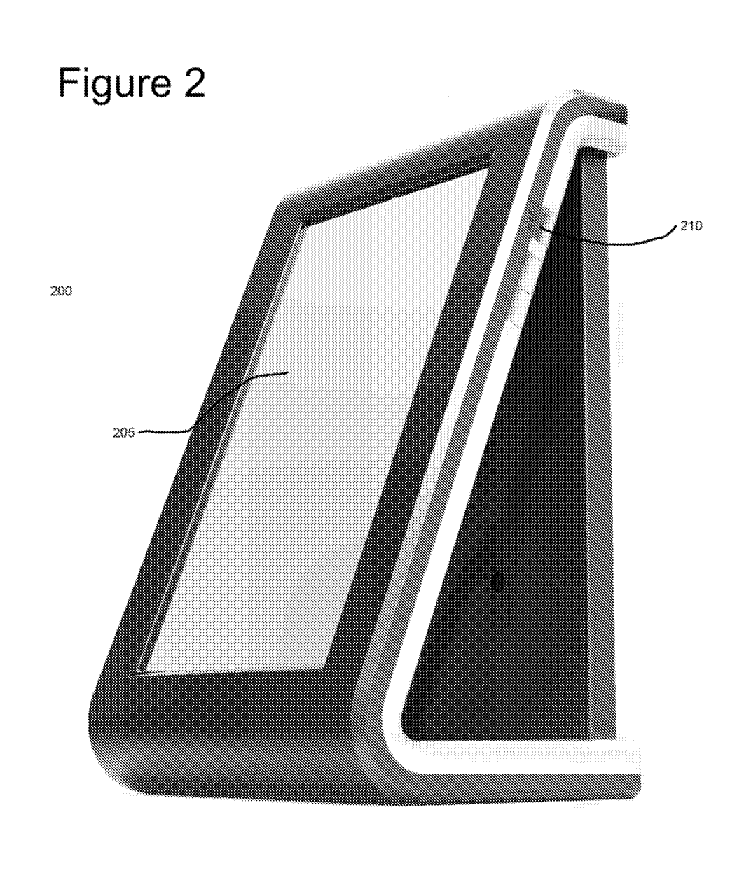

Alternatively, the device shown in FIG. 1 can be embedded into a larger system, for example an embodiment such as a tablet as shown in FIG. 2. In such an embodiment, the tablet 200 includes a display 205 with appropriate electronics [not shown] enclosed within the housing. An RJ-45 jack, indicated at 210, provides the PoE signal to the device, and, more specifically, to the interface system shown in FIG. 1, also included in the electronics within the housing. Thus, the only connection a tablet 200 needs for both power and internet access is the PoE connection, through the RJ-45 jack 210, to the system of the present invention. The invention can also be appreciated as comprising a method for bidirectional conversion of communications between IP protocol and USB protocol. In an embodiment, the method comprises A method for converting standard Ethernet PoE data and power to USB 3.0 standard data and power comprising the steps of providing a first input/output port for connection to Ethernet PoE signals, converting the Ethernet PoE input voltage to 5 VDC, providing a second input/output port for connection to USB 3.0 signals, providing a bidirectional Ethernet-to-USB 3.0 communications interface connected between the first input/output port and the second input/output port for data exchange between the Ethernet signals and the USB 3.0 signals, and supplying appropriate power, such as 5 VDC, to the Ethernet-to-USB 3.0 communications interface and the USB port, as well as providing appropriate power, for example 1.2 VDC and 3.3 VDC, to the Ethernet-to-USB interface.

Given the foregoing detailed description of the invention and various alternatives, it will be appreciated by those skilled in the art that numerous alternatives and equivalents exist which do not depart from the invention. As a result, the invention is not to be limited by the foregoing description, but only by the appended claims.

What is claimed is:

1. A method for converting standard Ethernet PoE data and power to USB 3.0 standard data and power comprising the steps of
providing a first input/output port for connection to Ethernet PoE signals,
converting the Ethernet PoE input voltage to 5 VDC,
providing a second input/output port for connection to USB 3.0 signals,
providing a bidirectional Ethernet-to-USB 3.0 communications interface connected between the first input/output port and the second input/output port for data exchange between the Ethernet signals and the USB 3.0 signals, and
supplying 5 VDC to the Ethernet-to-USB 3.0 communications interface.

2. A system for converting standard Ethernet PoE data and power to USB 3.0 standard data and power comprising
a first input/output port for connection to Ethernet PoE signals, AC-DC converter for converting the Ethernet PoE input voltage to 5 VDC,
a second input/output port for connection to USB 3.0 signals,
a bidirectional Ethernet-to-USB 3.0 communications interface connected between the first input/output port and the second input/output port for data exchange between the Ethernet signals and the USB 3.0 signals, and
a connection for connection the 5 VDC to the Ethernet-to-USB 3.0 communications interface.

3. The system of claim 3 wherein the system is enclosed within an independent enclosure.

4. The system of claim 3 wherein the system is integrated into a device wherein power for the device is supplied by the system.
